(19) United States
(12) Patent Application Publication
(10) Pub. No.: US 2019/0337027 A1
(43) Pub. Date: Nov. 7, 2019

(54) Self cleaning condensate drain pressure trap

(71) Applicant: Jack Warren Raynes, II, Mesa, AZ (US)

(72) Inventor: Jack Warren Raynes, II, Mesa, AZ (US)

(21) Appl. No.: 15/894,204

(22) Filed: May 2, 2018

(51) Int. Cl. B08B 9/032; F24F 13/22

(52) U.S. Cl. CPC B08B 9/0321; B08B 2203/0223; F24F 2013/227; F24F 13/222

(57) ABSTRACT

The present invention comprises a self-cleaning condensate drain fluid pressure trap for air conditioning. Particulates present in the air which pass through an air conditioner adhere to moister (condensation) which is present on the internal evaporator coil. Condensation drips off the evaporator coil along with the particulates which has mixed in with it. Air-conditioning condensate fluid and particulates, or debris, accumulate inside an air-conditioner evaporator coil drain pan and are drained outward through the condensate fluid drain opening. Condensate fluid pressure traps, necessary accessories of a condensate drain line, are normally secured to the drain pan right outside of the air conditioners drain opening. Since condensate fluid is slow flowing, and not pressurized, debris that drains out of the air conditioner tends to settle in the bottom of the condensate fluid pressure trap. The debris will build up until a clog or restriction to drainage flow occurs. This description of events is based on my experience as an HVAC service technician and from cases gathered from other HVAC professionals.

This device, a self-cleaning condensate drain pressure trap for air conditioning, can prevent air conditioning condensate drain pan fluid overflows due to debris restrictions which occur in the condensate drain fluid pressure trap or elsewhere in the condensate drain line. In preferred embodiments a printed circuit board (PCB) is an incorporated part in the self-cleaning condensate drain pressure trap assembly. The PCB is designed to sense condensate fluid in the sensor cap at the high level of section 1a of the fluid pressure trap. Once the positive presence of fluid is sensed a relay on the PCB breaks the control voltage to the air-conditioners controls or thermostat. The invention then utilizes the incorporated fluid pump to circulate condensate drain fluid from section 1a of the pressure trap into section 1b of the pressure trap in a manner which is perpendicular to the normal fluid drainage flow through the fluid trap. This fluid pumping action loosens debris in section 1b and allows the drain fluid accumulated in the drain pan of the A/C unit to push the debris restriction out of the pressure trap by kinetic gravitational fluid force. After the debris is broken down and pushed through the fluid trap condensate drainage will resume. Unless there is another fluid restriction elsewhere in the drain line. When the PCB senses a negative presence of fluid at the sensor cap air-conditioner operations will be restored. If fluid drainage restrictions persist and a positive fluid presence at the sensor cap continues the PCB will continue to prevent the air conditioners operations. This will halt further production of condensate fluid to prevent condensate drain pan fluid overflow.

The (self-cleaning condensate drain pressure trap) is not intended to remedy all causes of condensate fluid drainage restriction. Nor is it designed to clean out the entire condensate drain line. The varied reasons for this this are listed in the ‘background of the invention’ section of this application. In short, problems that occur within condensate fluid drain lines are too varied in nature and the construction methods of said drain lines are vast as well. In my professional opinion, any attempt to solve all relative drainage issues with a single device is not practical. That is why this device merely intends to resolve condensate fluid drainage issues which occur due to the restriction of the condensate fluid through the condensate fluid pressure trap.

A device like (The self-cleaning condensate drain pressure trap) has been designed for the purpose of cleaning out entire condensate drain lines. The related patent (U.S. PG-Pub 2014/0130529), is flawed in certain embodiments where it is to be used. The device requires additional fluid trapping and/or elaborate external piping for it to function as a cleaning tool. It will experience failure(s) and/or cause damages when applied in condensate drain lines where more than one air conditioners share a common drain line or where drain line sections are not properly secured. The reasoning for these failures is laid out in the ‘background of the invention’ part of this application, sections (0004 thru 0007). These observations are based on my professional HVAC experience and the conclusions gathered by interview of other HVAC professionals.

Another patent (U.S. PG-PUB 2005/0138939) is shown to incorporate a fluid sensor, actuated by ‘electrode’. The patent in not unlike the engineered function of the PCB's fluid sensing ability described herein the (self-cleaning condensate drain pressure trap for air conditioning). However, it is laid out in the ‘background of the invention’ part of this application section (0012 & 0013) why the patent (U.S. PG-PUB 2005/0138939) is flawed in its design and is prone to failure. In short, the electrodes described therein are unshielded or unprotected from the moisture rich environment in which they are applied. This will cause failure of the device in a variety of manners from short cycling of the control systems to simple failure due to corrosion and/or retarded conductivity of the electrodes by surface contamination. The improved designs made herein the (self-cleaning condensate pressure trap for air-conditioning) are a method for fluid detection in condensate systems which functions in a superior manner. This method is a replacement to the use of fluid float controls and has been manufactured and tested to function in a superior manner as a fluid sensor. The sensor cap of (The self-cleaning condensate pressure trap for air-conditioning) is a fluid splash-guard for the wires, which are contained therein, that convey the presence of fluid to the PCB. The wires have a plastic coating as well to protect them from surface contamination. The sensor cap and wire designs were engineered after observations while testing fluid sensing models determined that these elements were required to ensure proper operation. These elements also enable the fluid sensing capabilities to continue in a prolonged state of usage in a moisture rich environment.

Finally, the engineering of the device (self cleaning condensate drain pressure trap for air conditioning) was kept as ergonomic as possible with as little parts as were necessary to perform the functions listed herein. In particular embodiments the device is constructed with materials that allow it to be used in indoor as well outdoor application. The device is resistant to U.V. rays, high ambient temperatures, debris and moisture. The device is light weight and can be supported merely by connection to the condensate drain line. The Installation method of (self cleaning condensate drain pressure trap for air conditioning) is the same as standard condensate fluid pressure traps, apart from the control wiring which must be connected to the air conditioner for cleaning and safety functions. Although, the device will function as a condensate fluid pressure trap whether power is applied or not.

### BACKGROUND OF THE INVENTION

The process of refrigeration, as used in air conditioning, produces liquid water via condensation of moisture present in air. Condensation fluid drips off evaporator coils located inside of air conditioners into a drain pan which is located underneath the coil. The fluid collected in the drain pan must be drained out of the A/C equipment, usually by a drain line which is attached to the units drain pan. The internal blower wheels operation causes a negative air pressure inside of the equipment. The negative air pressure will not allow condensate fluid to freely drain out of the cabinets drain connection while the equipment blower fan is running. This negative pressure forces the higher-pressure air outside the A/C unit to be sucked through the drain connection. A condensate fluid pressure trap is generally installed in the drain line to allow condensate fluid to fill a portion of the drain so that air won't be sucked through it. Condensate fluid will then freely drain out.

This device is specifically designed to deal with the problems that occur when condensate drain fluid pressure traps get clogged and obstruct normal fluid drainage. Condensate pressure traps, or ‘p-traps’, become clogged with particulate matter that is present in the air flow within an air-conditioner. The particulates cling to and mix with condensed moisture on the evaporator coil. The mixture then drips off the coil into the drain pan and out into the condensate fluid trap. Condensate fluid is not pressurized and slow flowing. The particulate debris in the condensate fluid settles in the bottom of the p-trap. The condensate trap becomes clogged when enough debris has settled to restrict the flow of fluid. The fluid then backs up into the air conditioners condensate drain pan. Eventually the condensate fluid will flow over the top of the A/C drain pan and spill over inside the air conditioning unit. When an A/C unit floods internally, the fluid flows into ducting, runs out of the unit, and in general damage occurs.

Devices have been developed to recognize when condensate fluid backs up into an air conditioners condensate drain pan. These devices generally consist of a float connected to a relay. Upon a rise in the drain pan fluid level the float will actuate the relay and disconnect control voltage to the air conditioner. A/C unit operations are then shut down. An HVAC service technician is generally required to inspect the downed A/C equipment and clear the drain restrictions to restore condensate fluid flow. Until a service person can arrive and repair the issue, or the condensate fluid level recedes normally, the air conditioning equipment will be down. This scenario can be a dangerous situation in many cases where extreme ambient temperatures are involved, or when critical temperatures must be regulated such as in laboratories or food storage.

There is a device (U.S. PG-Pub 2014/0130529) which is disclosed as comprising “A condensate management system for an air conditioning condensate drain”. This device (U.S. PG-Pub 2014/0130529) claims, in abbreviation, to use a fluid pump attached to the condensate drain line of an air conditioner to flush out the condensate fluid drain by “clearing obstructions along the entire condensate drain system flow path”. This flushing action is shown to be in parallel to the normal flow of the condensate drain fluid. Said device is shown by its listed figures (FIG. 5—part 35, FIG. 6—part 37, FIG. 8—part 35) and (FIG. 24, FIG. 25, FIG. 26, FIG. 27) to require external fluid pressure trapping or order for the device to function. These figures indicate that a fluid pressure trap is not an inherent part of the device and that a fluid trap will have to be applied elsewhere in its embodiments of an “intelligent condensate management system” in order to be “submerged in fluid” so that the device may operate. Therefore, the device embodied in (PG-Pub 2014/0130529) is not a fluid pressure trap and cannot function without the assistance of one or by incorporating elaborate external drainage piping to form a fluid pressure trap around the device.

The new device (self cleaning condensate drain pressure trap for air conditioning) does not require external fluid pressure trapping or elaborate drain piping in order to function. The device is by design a condensate fluid pressure trap. It is also not designed to “clear obstructions along the entire condensate system flow path” and it purposefully does not incorporate a high-pressure flushing force which is parallel to the normal flow of the condensate fluid drainage. The pump is low pressure and the fluid pumping motion, which is localized within the device, is perpendicular to the general condensate fluid drainage flow. There are several reasons for this.

Reason #1, condensate drain lines often have coupled joints that are not glued or otherwise connected properly, which is an effect of poor installation or age. Through years of professional HVAC service work I have found that pressurizing condensate drain lines can cause coupled joints to come apart, thereby causing an open end or leak in the drain line other than where the drain line was intended to drain to. When a coupling between two sections of drain line comes apart the effect will be fluid damage and safety concerns.

Reason #2, there are often multiple drain lines connected to one another in order to rout the drainage of multiple air conditioners to one main designated drainage area. When blowing fluid or gas through an air conditioners condensate drain line which is coupled to other air conditioner drain lines there are several consequences. Consequence (a) drain fluid is blown inside the other A/C equipment for which the effected A/C unit is coupled to, causing secondary fluid and debris damage. Consequence (b) ‘clean-outs’ or open-air vents are usually installed in condensate drain lines, on the outside of an A/C unit near the drain connection. Clean-outs allow air to assist in the drainage of condensate fluids by alleviating negative air pressure. When condensate drain lines that are coupled to drain lines of other A/C equipment are pressurized the coupled clean-out(s) effectively become open geysers that spray fluid and debris from the air vent. These types of damages can and will be caused by the application and usage of the device patented (U.S. PG-Pub 2014/0130529).

The pump function described in patent (U.S. PG-Pub 2014/0130529) is to “clear obstructions along the entire condensate system flow path”. Whereas the function of the fluid pump in the new device (self cleaning condensate drain pressure trap for air conditioning) is only to loosen debris clogs in section 1b of the device's fluid trap, where debris is known to gather and restrict condensate fluid drainage. The debris restriction is loosened by circulating condensate fluid from section 1a (FIG. 1) of the fluid trap body into section 1b (FIG. 1) of the trap body. The pumping motion of the fluid is perpendicular to the normal drainage fluid motion through the device and condensate line. The fluid pumping is localized within the device sections 1a and 1b and does not extend to the rest of the condensate drain line.

The pump is actuated by the device's printed circuit board (PCB) when the condensate fluid has risen to a high level within section 1a of the fluid pressure trap body. At this level there is generally as much as a half-gallon or more of fluid potential energy accumulated in the air conditioners condensate drain pan. Upon actuation the pump circulates the fluid from section 1a to 1b to loosen the debris clog by breaking it down into particulates. Breaking the clog down into particulates lessens the inertia coefficient of the debris. In other words, it loosens the debris hold on the inside of the device. As the inertia coefficient of the debris particulates becomes less than weight of the condensate fluids pushing on them from the drain pan the kinetic energy of the fluid pushes the debris out of the devices trap by gravitational force. To review, the pump breaks the clog down into particulate form so the volume of water accumulated behind the clog can push the particulates out of the fluid trap.

The device (U.S. PG-Pub 2014/0130529) uses a floating switch, or float, to signal to that device's logic panel (a.k.a. printed circuit board) of a condition in which condensate fluid has risen to high level. This process is the actuation method of that device. There are drawbacks to using floats as a method of recognizing the presence of fluids. First, floats are bulky and add dimension to devices. Second, floats are mechanical by design and are prone to degradation by dirt, debris, chemicals, oxidation and bacterial slime which impede their operation.

The (self cleaning condensate drain pressure trap for air conditioning) does not incorporate a float to report the presence of condensate fluid for the reasons listed above. The device instead uses a printed circuit board that senses the presence of fluid. The PCB's sensor function is extended via two wires into the device's sensor cap 2, which is inserted into section 1a of the trap body.

In another patent (U.S. 2005/0138939) the device is specified to incorporate “a fluid level sensor having sensing probes or electrodes to sense excess condensate in the hollow body”. The sensor described within the patent (U.S. 2005/0138939) shown in its (FIG. 3—part 94) depicts two rods of unshielded conductive material descending into a fluid reservoir tank. That devices design differs from the fluid sensor described in the (self cleaning condensate drain pressure trap for air conditioning). Here, the wires which extend from the PCB are encased within a sensor cap and are further shielded by a plastic coating over the wires. Only ⅛ inch of each wire is exposed for the purpose of sensing condensate fluid. The sensor cap encapsulates the sensor wires to shield them from the condensate fluid that would normally splash on them. Fluid splashing on the sensor, or electrodes, will cause a short cycling effect that inaccurately relays the presence of fluid to the device's controls. The sensor cap and wire coating also protect the sensor wires from exposure to dirt, debris and slime as well as corrosion.

The sensor probes in patent (U.S. 2005/0138939) are not protected and are susceptible to these factors. The sensor cap and wire coating in this application are improvements to the fluid sensing electrode device previously patented. Without these improvements short cycling of the device and consequently the air conditioner will occur. The device (U.S. 2005/0138939) will also experience failure when the probes are unable to conduct electrons due to insulation by a surface debris coating, such as bacterial slime, or are otherwise caused to fail because the sensors have corroded away. Corrosion of the electrodes would have the effect of changing the level at which fluid was reported, most likely to a higher level. This effect would not prevent condensate fluid flooding as was described as the purpose for that invention.

When examining all the factors listed above it is shown that a need exists for the (self cleaning condensate drain pressure trap for air conditioning). As a professional HVAC technician, who has studied the condensate drainage problem extensively, I can say that this device is needed in the HVAC industry. A condensate fluid trap that cleans itself which also functions as a condensate fluid level safety shutoff has applications in residential, commercial and industrial air conditioning. The reasoning behind the safety shut-off feature is that restriction to drainage flow may exist elsewhere in the condensate drain line. With this added feature the air-conditioner is twice protected from condensate fluid restrictions and overflows.

The electrical installation procedures are straight forward and less complicated than most thermostat wiring is. The device is powered by the control voltage supplied by the air conditioning equipment it is servicing. The amp draw is small enough that it will not harm existing A/C control surfaces or cause strain to them. It installs in the same manner as a standard condensate pressure trap does. The size and shape of the device are relative as well. It is light weight and does not have to be supported by resting on the ground, or other platform, and it can be universally used on most air conditioners. In preferred embodiments, the construction materials and design make it resistant to UV rays, dirt, heat and moisture. The (self cleaning condensate drain pressure trap for air conditioning) was engineered to perform better than any previous device designed to protect against condensate drain fluid backups and the flooding that occurs as a result.

In conclusion, the problems that occur in condensate systems are varied and many. It's not probable for there to be any single solution for all problems related to condensate fluid drains. However, from data collected by interview, internet and my professional HVAC service I have concluded that clogged condensate drain fluid pressure traps are the majority cause of condensate fluid overflow problems and the flooding that occurs as a result. The (self cleaning condensate drain pressure trap for air conditioning) is a rigorously laboratory tested and viable solution for condensate drainage problems.

### BRIEF SUMMARY OF THE INVENTION

This invention is an air conditioning condensate drain fluid pressure trap that incorporates a printed circuit board, with fluid sensing capabilities, to recognize when condensate fluid rises to high level within the sensor cap of the pressure trap section 1a.

As the inventions printed circuit board (PCB) positively senses fluid within the sensor cap in section 1a the PCB breaks voltage to the air conditioning system controls. This function shuts down the operation of the air conditioning system, preventing the further production of condensate fluid.

The inventions PCB will then energize the fluid pump to circulate fluid from section 1a of the condensate pressure trap into section 1b of the pressure trap. Section 1b is the bottom of the pressure trap where debris is known to collect. The fluid circulation breaks down restricting debris lodged in the pressure traps section 1b into particulates. Generally, about a half-gallon or more of fluid potential energy, caused by drainage restriction, is built up in the air conditioners condensate drain pan. This fluid potential energy is bearing down on the debris restriction in the device. As the pump breaks down the debris the debris' inertia coefficient becomes less than the weight of the accumulated fluid. The fluid in the drain pan then pushes the debris particulates through the device by gravitational fluid force. To summarize, the fluid pump does not flush out the condensate trap or any connected drain line(s). The pump is also not designed for “clearing obstructions along the entire condensate drain system flow path”. The fluid pump merely assists condensate drainage fluid flow by breaking down the debris restriction to smaller particles within the fluid trap.

After condensate fluid flow is regained through the fluid pressure trap and the PCB senses a negative fluid presence within the sensor cap the PCB will deactivate the fluid pump, after a 15 second delay. The PCB then restores voltage to the air conditioning systems controls. Normal operation of the air conditioning system will then resume.

This device was intentionally designed to only assist in the natural drainage of condensate fluids. Attempting to blow out condensate drain lines by pressurized the lines with air or fluid has been proven in the HVAC field to cause damages. These damages include blowing drain lines apart, spraying muddy condensate water into connected air conditioners and spraying muddy condensate water through the air vents that exist in condensate drain lines. All of which cause water and debris damages which was the symptom of clogged condensate drain lines that was trying to be avoided in the first place. It should be noted that HVAC technicians generally use a vacuum at the exit point of condensate drain lines to attempt to clear these restrictions for these very reasons.

### BRIEF DESCRIPTION OF THE DRAWINGS

Some embodiments of the present invention are illustrated as an example and are not limited by the figures of the accompanying drawings, in which like references may indicate similar elements and in which:

FIG. 1—FIG. 1 depicts an exploded perspective view of a self-cleaning air conditioning condensate drain pressure trap according to various embodiments of the present invention.

FIG. 2—FIG. 2 Illustrates an exposed and partially exploded mechanical side profile view of one example of a self-cleaning air conditioning condensate pressure trap according to various embodiments described herein.

FIG. 3—FIG. 3 shows an exposed mechanical side profile view (reverse of FIG. 2) of one example of a self-cleaning air conditioning condensate pressure trap according to various embodiments described herein.

FIG. 4—FIG. 4 depicts an example of an encapsulated front side profile view of a self-cleaning air conditioning condensate pressure trap according to various embodiments described herein.

FIG. 5—FIG. 5 shows an example of an encapsulated side profile view (reverse of FIG. 4) of a self-cleaning air conditioning condensate pressure trap according to various embodiments described herein.

### DETAILED DESCRIPTION OF THE INVENTION

The terminology used herein is for describing particular embodiments only and is not intended to be limiting of the invention.

Unless otherwise defined, all the terms used herein have the same common meaning as understood by one having ordinary skill in the art to which this invention belongs. It is to be understood that the terms used herein will have the same common meaning as they are to be described in a common English dictionary, the terms should also be interpreted by any relative meaning that they would have in the context of relative art.

In describing the invention several techniques will be disclosed. Each technique described will be of benefit to itself and possibly of others in the description, or to all. This description will refrain from repeating various steps in unnecessary fashion for the purpose of clarity. The specification and claims should be read as so these descriptions are within the scope of the invention and claims.

A new self-cleaning condensate drain pressure trap for air conditioning systems will be disclosed herein. The following descriptions will explain the specific details in the operations of the device This disclosure is an example of the invention, and it is not intended to limit the invention to the specific uses that are illustrated by the figures and descriptions below.

This disclosure is an example of the invention, and it is not intended to limit the invention to the specific uses that are illustrated by the figures and descriptions below.

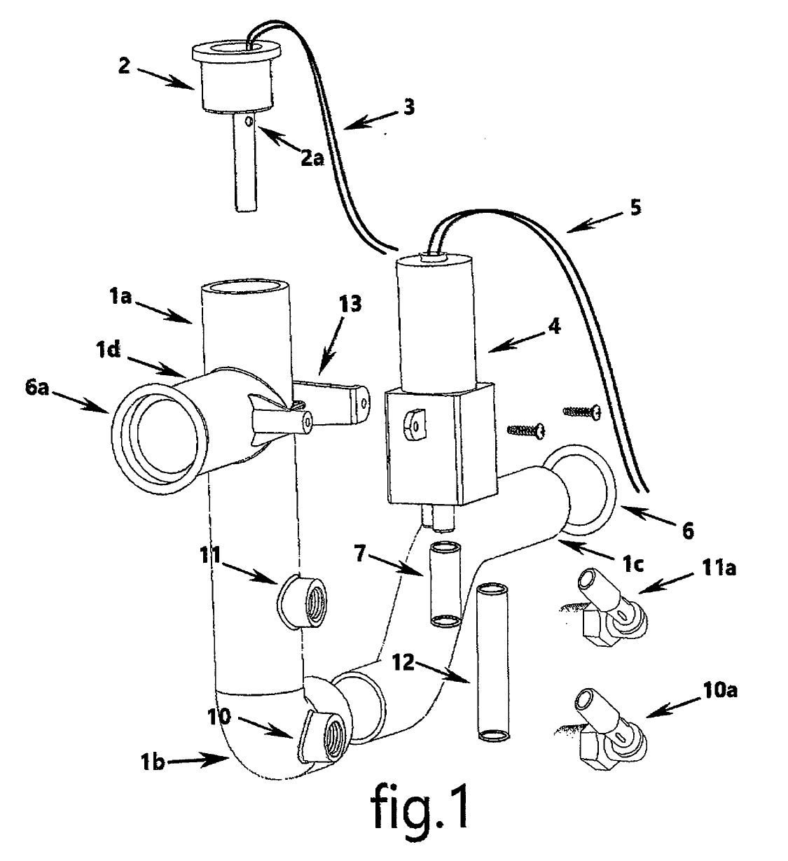

The present invention will now be described referencing the appended figures representing preferred embodiments. FIG. 1. Depicts an exploded perspective view of the elements that may comprise a self-cleaning condensate drain pressure trap for air conditioning usage according to various embodiments of the present invention. In preferred embodiments each device is configured with at least one modified condensate drain pressure trap comprised of sections 1a, 1b, 1c and 1d. The pressure trap 1a-d is molded plastic with several molded plastic appendages; 10,11 & 13. Appendage 11 is a female threaded port that extends from the pressure trap body 1a and is used as a drain fluid exit port. Appendage 10 is a female treaded port that extends from the pressure trap body 1b and is used as drain fluid entrance port. Appendage 13 is a mounting bracket tab with a screw hole on each side used for mounting pump 4 onto the pressure trap body.

A plastic sensor cap 2 is the housing for the wires 3 that connect to the PCB wire terminal marked ‘sensor’. The wires 3 relay the presence of fluid when fluid is at a high level in the trap body section 1a. On the top of the trap body section 1a the pipe end is open. The sensor cap 2 is glued and inserted into 1a until both parts are flush with one another, the down tube of the sensor cap is maneuvered toward the rear of 1a away from the drain fluid entrance 1d. Near the top end of the wire guide down tube, on the bottom half of the sensor cap 2, there is a small orifice 2a in the side. The orifice 2a is an air pressure relief for when fluid rises into the sensor cap 2.

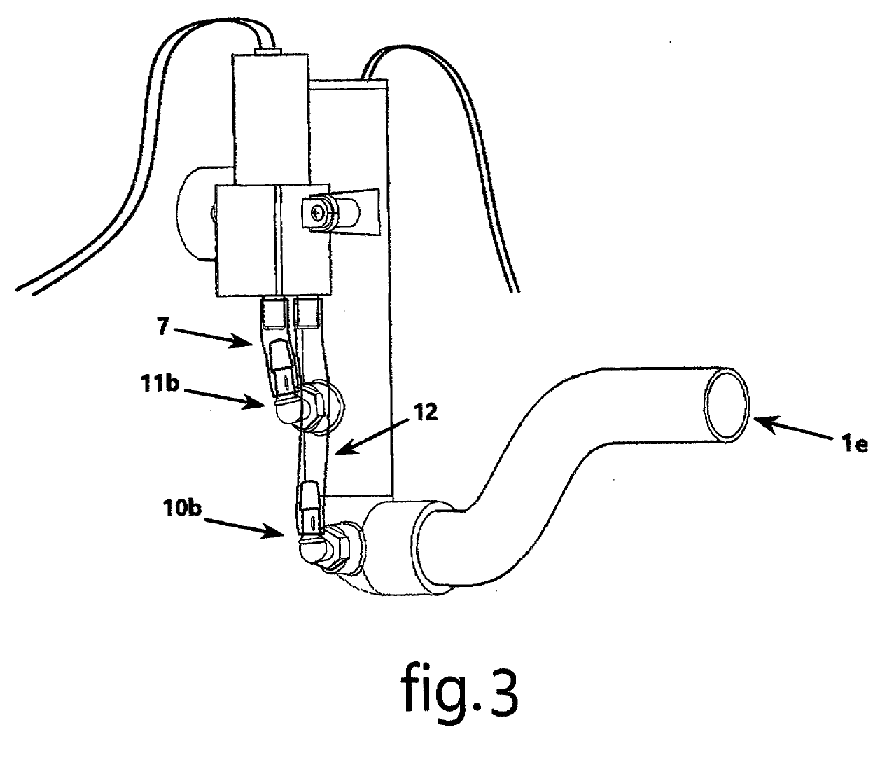

In preferred embodiments, the plastic barbed elbows 10a and 11a will have resin applied to their male treads and are then screwed into their prospective female threaded ports 10 and 11 (best visualized in FIG. 3). The bottom end of Tube 7 will be glued and inserted onto barb 11a and also tube 12 bottom end will be glued and inserted onto barb 10a. The pump 4 inlet is then glued and inserted into the top of tube 7 and the pump 4 outlet glued and inserted into the top of tube 12. The pump 4 is mounted onto bracket 13 and secured with screws. Pump 4 power wires 5 are then routed to the inventions PCB 8 and inserted/secured into the wire terminals labeled ‘pump’.

In preferred embodiments, the PCB control 8 is mounted onto bracket 18a on rear housing 18 and secured with two screws.

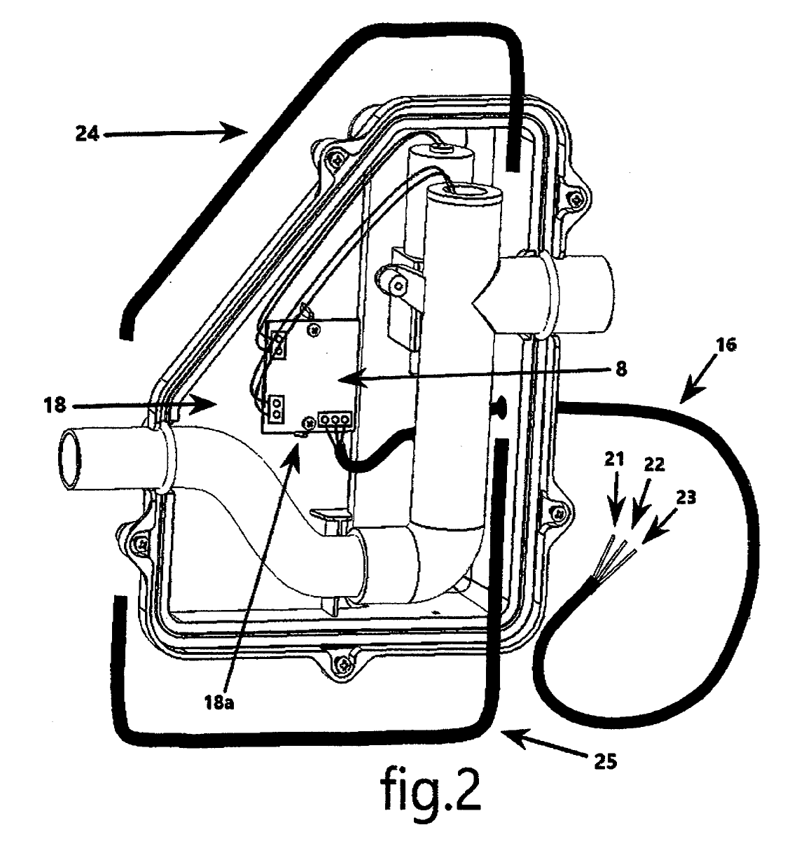

In preferred embodiments, Wires 21, 22 and 23 are connected to the invention's PCB control 8. This embodiment is best visualized in FIG. 2. Wire 21 is the air conditioners 24-volt control return wire and is inserted/secured into the PCB 8 wire terminal labeled ‘24 vac out’. Wire 22 is the air conditioners 24-volt control wire and is inserted/secured into the PCB 8 wire terminal labeled ‘24 vac in’. Wire 23 is the air conditioners common/ground wire and is inserted/secured in the PCB 8 wire terminal labeled ‘common’. Wires 21, 22 and 23 converge in a single shielded cord 16 which is embodied in FIG. 2 and is the electrical interface between the invention and the air conditioning unit the device is servicing. Outer cover seals 24 and 25 are also depicted in FIG. 2. Seals 24 and 25 protect the internal elements of the device from moisture and debris and are placed in the grove where outer covers 15 and 18 mate.

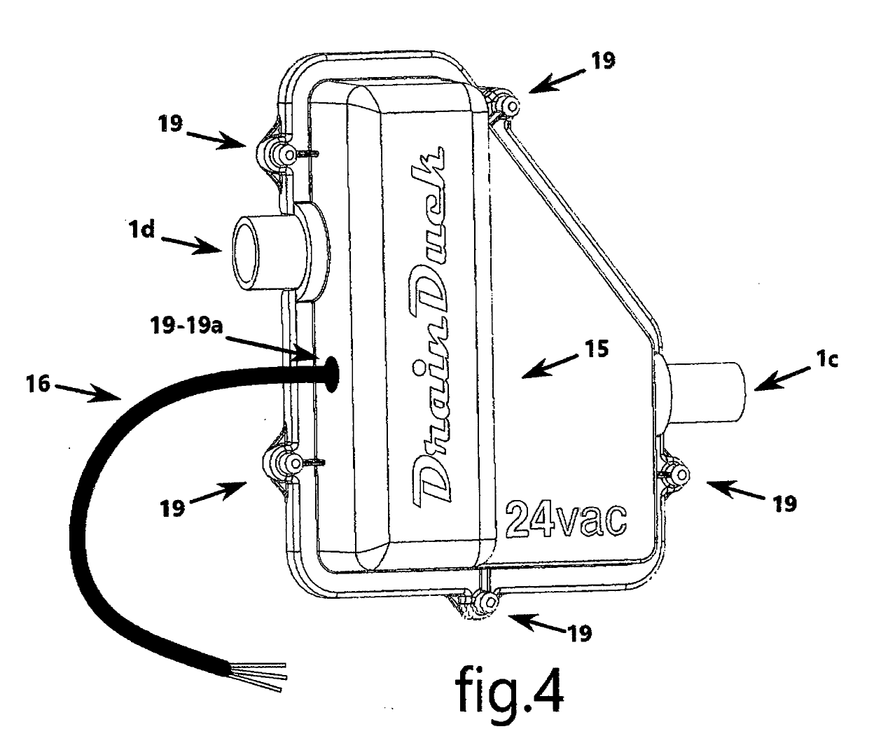

FIG. 4 illustrates an encapsulated front side profile view of an example of some components which comprise a self-cleaning condensate drain pressure trap according to the present invention. In this figure an example of a plastic front outer cover 15 for the invention is depicted. The purpose of the cover 15 and rear cover 18 is to protect the invention from moisture, dirt, sunlight and heat which would damage internal parts of the invention. All around the perimeter of the front cover 15 are the female screw bosses 19. There is a hole 9 in the cover 15 where a rubber grommet 9a is inserted. The power cable 16 is inserted through the grommet 9a. Part 1d, the mounting port of the fluid trap body where the invention is attached to the air conditioner drain pipe, protrudes from the cover 15 and is the devices main condensate fluid inlet. Weep hole 20 is located at the bottom of cover 15 for a drainage port for any moister which may collect inside the protective cover.

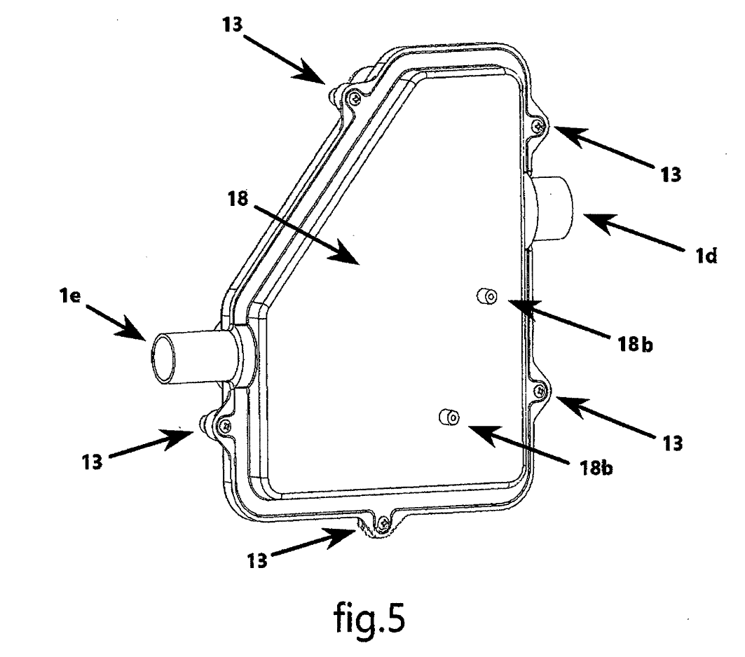

Referring to FIG. 5, in this embodiment screw bosses 13 are located on the perimeter of rear cover 18 to secure rear cover 18 to the front cover 15 with screws. Fluid trap section 1e, seen protruding from the rear cover 18 in FIG. 5, is the main condensate fluid exit port of the invention and is where any further condensate drain line is attached.

While preferred materials for elements have been described, the device is not limited by these materials. Any materials such as rubber, foam, aluminum, wood or any material which the device could be fashioned from may comprise some or all the elements of the self-cleaning condensate drain pressure trap in various embodiments of the present invention.

Although the present invention has been illustrated and described herein with reference to preferred embodiments and specific examples, it will be readily apparent to those of ordinary skill in the art that other embodiments and examples may perform similar functions and achieve like results. All such equivalent embodiments and examples are within the spirit and scope of the present invention, are contemplated thereby, and are intended to be covered by the following claims

What I claim:

1. (canceled)

2. (canceled)

3. A self-cleaning condensate drain pressure trap for air conditioning the device comprising:
a condensate fluid pressure trap with a slope of 25% from drain inlet downward to the drain outlet which is consistent with standard air conditioning drain fluid pressure traps and complies with international mechanical code 307.2.1;
a fluid outlet appendage 11 & 11a on section 1a of the pressure trap body is perpendicular to the main flow of condensate drain fluid and on which hose 7 is attached for the purpose of circulating condensate drain fluid out of section 1a;
a fluid inlet appendage 10 & 10a on section 1b of the fluid pressure trap body is perpendicular to the main flow of condensate fluid and on which hose 12 is attached for the purpose of circulating condensate fluid into section 1b;
a fluid pump 4 attached by molded bracket to the condensate fluid trap body;
a printed circuit board 8 attached to cover 18 by molded bracket 18a is the devices controller;
a sensor cap 2 which is inserted into the top of the pressure trap section 1a to act as a wire guide and fluid splash protector for the sensor wires 3 of the previously listed circuit board;
an outer cover consisting of front 15 and back 18 sections for protection of the inventions circuit board, pump, pressure trap, hoses, and wires from moisture, dirt, heat and sunlight.

4. The fluid pump (referenced in claim 3) has the functions of:
circulating fluid via the pump 4 inlet from section 1a, part 11 of the fluid pressure trap body which is perpendicular to normal condensate fluid flow through section 1a of the fluid trap;
circulating fluid via the pump 4 outlet into section 1b, part 10 of the fluid pressure trap body which is perpendicular to normal condensate fluid flow through section 1b of the fluid trap;
lessening the inertia coefficient of the debris in fluid trap section 1b by breaking up the debris clog into smaller particulate matter;
enabling the kinetic energy of the accumulated condensate fluid to push the particulate debris through the trap body when the inertia coefficient of the debris becomes less than weight of the accumulated condensate fluid;

5. The printed circuit board 8 (referenced in claim 3) has the functions of:
a control platform for the device which is powered by voltage supplied by the connected air conditioners power supply;
a fluid sensor which is extended into the sensor cap 2 (referenced in claim 3) via two wires;
actuating via relay and wire terminal the previously listed fluid pump 4 to a ‘pump on’ function when positively sensing the presence of fluid between the wires in the sensor cap 2;
actuating via relay and wire terminal the fluid pump in claim 3 to a ‘pump off’ function 15 seconds after negatively sensing the presence of fluid between the wires in the sensor cap 2;
a control relay which breaks the control voltage of the A/C unit to the thermostat when there is a positive fluid presence at the sensor cap and alternatively conducts control voltage to the thermostat when there is a negative fluid presence.
